(19) United States
(12) Patent Application Publication
(10) Pub. No.: US 2026/0349714 A1
(43) Pub. Date: Nov. 5, 2026

(54) SYSTEMS AND METHODS FOR AGENTIC ARTIFICIAL INTELLIGENCE-BASED AUTOMATED CODE REVIEW AND FEEDBACK

(71) Applicant: Alexandr Sorokoletov, Falls Church, VA (US)

(72) Inventor: Alexandr Sorokoletov, Falls Church, VA (US)

(21) Appl. No.: 19/629,144

(22) Filed: Mar. 26, 2026

Related U.S. Application Data
(60) Provisional application No. 63/784,117, filed on Apr. 6, 2025.

(51) Int. Cl. G06F 8/71; G06F 8/36; G06F 8/75

(52) U.S. Cl. CPC G06F 8/71; G06F 8/36; G06F 8/75

(57) ABSTRACT

A system and method for performing automated software code reviews using agentic artificial intelligence (AI), comprising a code ingestion module for receiving code changesets from source control systems, an agentic AI module that autonomously plans and orchestrates review workflows by selectively invoking external analysis tools and optional sub-agent modules based on contextual metadata and repository-specific configuration, a hierarchical configuration subsystem customizable per-repository, per-organization, per-team, or per-user, and a feedback delivery engine for transmitting structured, context-sensitive review feedback in natural language through inline repository comments, command-line interfaces, email, or application programming interfaces.

### CROSS-REFERENCE TO RELATED APPLICATIONS

This application claims the benefit of U.S. Provisional Application No. 63/784,117, filed Apr. 6, 2025, the entire disclosure of which is incorporated herein by reference.

### FIELD OF THE INVENTION

The present invention relates to automated software engineering systems, and more particularly to intelligent, agent-driven systems and methods for performing software code reviews using artificial intelligence (AI) in combination with configurable static and dynamic analysis tools.

### BACKGROUND OF THE INVENTION

### Technical Field Context

Software code review is a critical practice in modern software development, serving to identify defects, enforce coding standards, improve maintainability, and facilitate knowledge transfer among development team members. As software systems grow in complexity and development teams become increasingly distributed, the demand for efficient, consistent, and scalable code review processes has intensified.

### Limitations of Manual Code Review

Manual code review, while valuable for its human insight and contextual understanding, suffers from several well-documented limitations. Human reviewers are subject to fatigue, inconsistency, and varying levels of expertise. Review turnaround times can create bottlenecks in development workflows, particularly when reviewers are unavailable or when the volume of code changes exceeds team capacity. Additionally, manual reviews often focus on surface-level issues while missing deeper architectural or security concerns that require specialized knowledge.

### Limitations of Conventional Automated Approaches

Existing automated code analysis tools, including static analyzers, linters, and security scanners, address some of these limitations but introduce their own constraints. These tools typically operate with fixed rule sets that must be manually configured and maintained. They execute in predetermined sequences without regard to the specific context of the code changes being reviewed. Their output is typically in the form of structured warnings or error messages that lack the contextual explanation and nuanced feedback that characterizes effective human code review.

### Limitations of Prior AI-Based Approaches

More recently, machine learning approaches have been applied to code review, including systems that train neural models on historical code review data to predict likely review comments (see, e.g., data-driven code review using deep learning). While these approaches can generate context-aware feedback, they typically rely on a single AI model operating in isolation, without the ability to dynamically invoke external analysis tools, delegate specialized tasks to sub-agents, or adapt their review strategy based on repository-specific configuration. Additionally, prior approaches that use large language models (LLMs) for code review comment generation typically employ fixed prompt templates or retrieval mechanisms, lacking an autonomous agent capable of planning and orchestrating a multi-faceted review process.

### Need for an Agentic Approach

There exists a need in the art for a code review system that combines the contextual understanding and natural language capabilities of modern AI with the precision of specialized analysis tools, while providing the flexibility to adapt to diverse development environments, organizational policies, and individual developer preferences. The present invention addresses this need through an agentic AI architecture that autonomously orchestrates customizable, multi-tool code review workflows.

### BRIEF DESCRIPTION OF THE DRAWINGS

FIG. 1 is a high-level system architecture diagram illustrating the primary modules of the automated code review system and their interactions, including the code ingestion module, the agentic AI module, the configuration subsystem, external analysis tools, sub-agent modules, and the feedback delivery engine.

FIG. 2 is a detailed flowchart illustrating the operational workflow of the agentic AI module, including code changeset reception, contextual metadata evaluation, review strategy determination, dynamic tool and sub-agent invocation, output aggregation, feedback synthesis, self-review evaluation, and feedback delivery.

### DETAILED DESCRIPTION OF EMBODIMENTS

The following description sets forth specific details in order to provide a thorough understanding of the present invention. It will be apparent to those skilled in the art that the present invention may be practiced without some of these specific details. In other instances, well-known structures and techniques have not been described in detail to avoid unnecessarily obscuring the present invention.

While the disclosed technology may be embodied in many different forms, there are shown in the drawings and described herein in detail several specific embodiments with the understanding that the present disclosure is to be considered as an exemplification of the principles of the technology and is not intended to limit the technology to the embodiments illustrated. The terminology used herein is for the purpose of describing particular embodiments and is not intended to limit the technology.

### Terminology and Definitions

The following terms are used throughout this specification and are defined as follows:
AI Agent (Agentic AI Module): A planning-capable software module driven by one or more machine learning models, including but not limited to large language models (LLMs), neural networks, or expert systems, capable of autonomously orchestrating code review tasks. The AI agent evaluates contextual information, determines review strategies, selects and invokes tools or sub-agents, and synthesizes feedback without requiring step-by-step human direction for each review action.
Sub-Agent Module: A modular, role-specific component within the system, invoked by the agentic AI module to perform scoped analytical tasks using context-rich inputs. Unlike external tools, which operate as black-box utilities, sub-agent modules participate in a delegation protocol where their invocation, inputs, and expected outputs are coordinated by the agentic AI module as part of a broader reasoning and planning step. For example, a security sub-agent may receive a narrowed subset of files or diff context with specific goals such as vulnerability pattern matching, and return structured signals that contribute to the final synthesized feedback. Sub-agent modules may themselves incorporate machine learning models or AI capabilities.
External Analysis Tool: Software utilities including but not limited to linters, static analyzers, security scanners, compilers, code formatters, performance profilers, dependency analyzers, and accessibility checkers. These tools are invoked by the agentic AI module to extract code-level signals. The internal operation of these tools (whether heuristic-based, rule-based, or data-driven) is not dictated by the system. The orchestration logic of the agentic AI module does not rely on prior human review data or model retraining for tool selection.
Code Changeset: A set of software code modifications submitted for review, including but not limited to commits, pull requests, merge requests, patches, or file diffs. A code changeset may span multiple files, multiple programming languages, and multiple file types including text, binary, image, configuration, and multimedia files.
Contextual Metadata: Information associated with a code changeset that informs the review strategy, including but not limited to: author identity, commit history, file types, programming languages, directory structure, merge request or pull request description, continuous integration (CI) pipeline status, repository-specific configuration rules, organizational policies, and code complexity metrics.
Dynamic Orchestration: The process by which the agentic AI module selects, sequences, and invokes external analysis tools and sub-agent modules in a non-predetermined order based on contextual evaluation. This is distinguished from traditional static tool pipelines that execute tools in a fixed, predetermined sequence regardless of the code being analyzed.
Review Strategy: A plan determined by the agentic AI module for how to analyze a given code changeset, including which tools and sub-agents to invoke, in what order, with what inputs, and what quality thresholds to apply to the resulting feedback.

### Embodiment 1: System Architecture

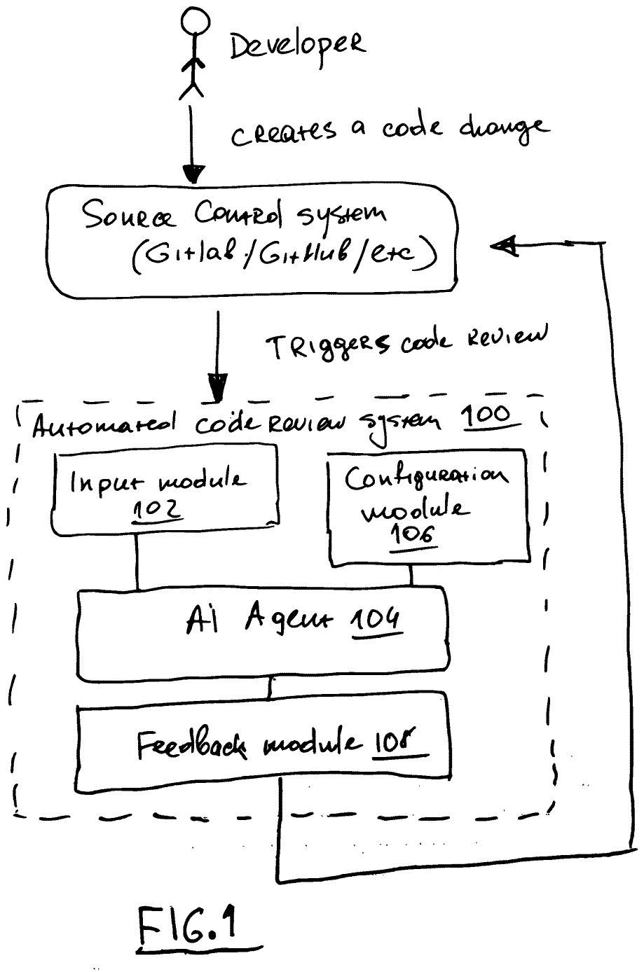

Referring now to FIG. 1, in one embodiment, the invention is implemented as a modular architecture comprising the following components:

### 1. Code Ingestion Module (102)

The code ingestion module 102 is configured to receive software code changesets from one or more source control systems, including but not limited to Git-based systems (e.g., GitHub, GitLab, Bitbucket), Mercurial, Subversion, or Perforce. The code ingestion module 102 supports multiple trigger mechanisms:
Webhook-based triggers: The code ingestion module 102 exposes one or more webhook endpoints that receive event notifications from source control systems when code changes are submitted (e.g., pull request creation, push events, merge request updates).—CLI-based triggers: A command-line interface allows developers to manually initiate code review for specific changesets, branches, or files.—API-based triggers: A REST or GraphQL API enables programmatic initiation of code reviews by external systems, CI/CD pipelines, or other automated processes.

Upon receiving a trigger, the code ingestion module 102 retrieves the relevant code changeset, including file diffs, full file contents where applicable, and associated metadata such as commit messages, author information, and branch context.

### 2. Agentic AI Module (104)

The agentic AI module 104 is the central orchestration unit of the system. It receives the code changeset and associated metadata from the code ingestion module 102 and autonomously plans and executes a code review workflow. The agentic AI module 104 comprises:
Planning Component: Evaluates the code changeset, contextual metadata, and configuration parameters to determine a review strategy. The planning component considers factors including file types present in the changeset, programming languages used, the scope and complexity of changes, repository-specific rules, and organizational policies.
Orchestration Component: Executes the review strategy by selectively invoking one or more external analysis tools 204 and/or sub-agent modules 202. The orchestration component determines which tools to invoke, in what order, and with what inputs. This orchestration is dynamic—the sequence and selection of tools is not predetermined but is determined at runtime based on the specific characteristics of each code changeset and the intermediate results obtained during the review process.
Synthesis Component: Aggregates the outputs from all invoked tools and sub-agents and synthesizes them into coherent, structured, context-sensitive review feedback expressed in natural language. The synthesis component uses one or more machine learning models, which may include large language models (LLMs), to generate feedback that is linguistically natural, contextually relevant, and actionable.
Self-Review Component: Evaluates the synthesized feedback against configured quality thresholds, completeness criteria, and contextual relevance measures. If the feedback does not satisfy these criteria, the self-review component may trigger additional analysis by re-invoking tools or sub-agents with adjusted parameters, requesting additional context, or refining the synthesis.

The agentic AI module 104 is capable of processing code changesets comprising various file formats including text files, binary files, image files, configuration files, and multimedia files.

### 3. Configuration Subsystem (106)

The configuration subsystem 106 provides a flexible, hierarchical configuration mechanism that governs the behavior of the agentic AI module 104. Configuration parameters may be specified at multiple levels:
Organization level: Default policies and tool selections applicable across all repositories within an organization.—Repository level: Overrides and additions specific to a particular code repository, stored as machine-readable configuration files (e.g., YAML, JSON, TOML) within the repository itself.—Team level: Configuration specific to a development team's practices and preferences.—User level: Individual developer preferences for feedback style, verbosity, and focus areas.

Configuration parameters govern aspects including but not limited to: which external analysis tools to enable or disable, feedback scope and depth, output formatting and structure, quality thresholds for the self-review component, custom review rules and guidelines, and delivery channel preferences.

The hierarchical structure supports inheritance with override capability, wherein more specific levels (e.g., user) override less specific levels (e.g., organization) for applicable parameters.

### 4. External Analysis Tools and Sub-Agent Modules

External Analysis Tools (204): The system supports integration with a variety of external analysis tools, including but not limited to:—Static code analyzers (e.g., for detecting code smells, complexity issues, potential bugs)—Linters (e.g., for enforcing coding style and formatting conventions)-Security scanners (e.g., for detecting vulnerabilities such as SQL injection, cross-site scripting, insecure dependencies)—Compilers and build tools (e.g., for detecting compilation errors or type mismatches)—Performance profilers (e.g., for identifying potential performance bottlenecks)—Accessibility checkers (e.g., for evaluating compliance with accessibility standards in web-related code)—Dependency analyzers (e.g., for detecting outdated, vulnerable, or conflicting dependencies)

External tools may be invoked via shell commands, language-specific plugins, containerized services, or API calls.

Sub-Agent Modules (202): Sub-agent modules are specialized AI components that participate in a structured delegation protocol: 1. The agentic AI module 104 identifies a scoped analytical task suitable for delegation. 2. The agentic AI module 104 provides the sub-agent module with a narrowed context (e.g., a subset of files, specific diff sections) and specific analytical goals (e.g., “evaluate these files for SQL injection vulnerabilities”). 3. The sub-agent module performs its analysis using its specialized capabilities, which may include AI models, specialized knowledge bases, or domain-specific heuristics. 4. The sub-agent module returns structured results to the agentic AI module 104 for aggregation into the overall review feedback.

This delegation protocol distinguishes sub-agent modules from external tools in that sub-agents receive directed, contextual instructions and return structured analytical results as part of a coordinated reasoning process, whereas external tools receive standard inputs and produce their standard outputs.

### 5. Feedback Delivery Engine (108)

The feedback delivery engine 108 is configured to transmit the synthesized review feedback through one or more delivery channels:
Inline repository comments: Feedback is posted as inline comments at specific locations within the code changeset on the source control system's interface (e.g., pull request comments on GitHub, merge request discussions on GitLab).—Summary comments: An overall review summary is posted as a top-level comment on the pull request or merge request.—CLI output: For CLI-triggered reviews, feedback is formatted and displayed in the terminal.—Email notifications: Review feedback is sent to specified recipients via email.—Dashboard display: Feedback is presented on a web-based dashboard for monitoring and tracking.—API responses: Feedback is returned as structured data via REST or GraphQL API for consumption by other systems.

The feedback delivery engine 108 supports configurable output formatting, including the ability to customize the structure, verbosity, and presentation style of review feedback based on the delivery channel and configuration parameters.

### 6. Communication Infrastructure

Components of the system communicate using standard methods including but not limited to: HTTP/HTTPS, WebSocket connections, inter-process communication (IPC) mechanisms, message queues (e.g., RabbitMQ, Apache Kafka), and remote procedure calls (RPC). The specific communication method is selected based on deployment architecture and performance requirements.

### Embodiment 2: Operational Workflow

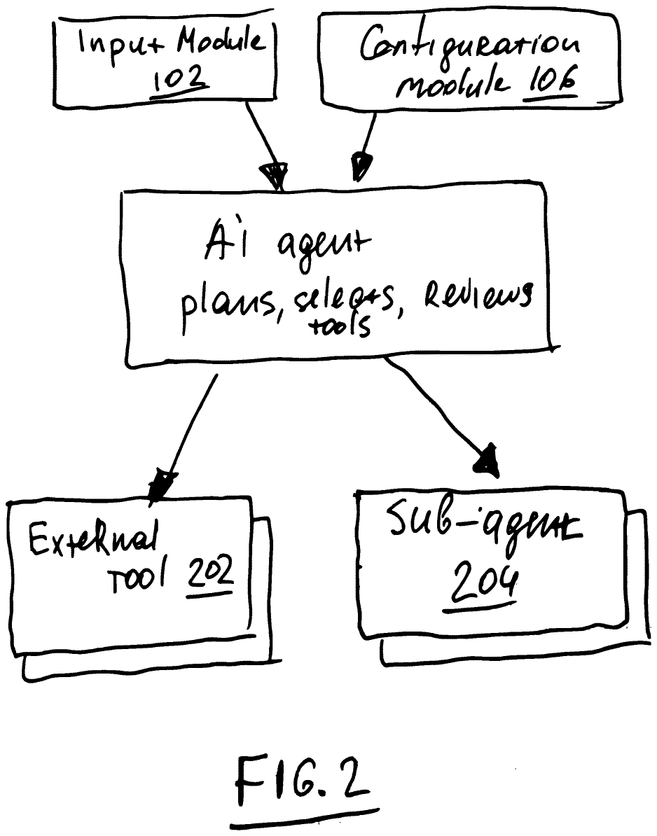

Referring now to FIG. 2, the operational workflow of the system proceeds as follows:
Step 1—Trigger and Ingestion: A developer pushes a commit or submits a merge request or pull request to a source code repository. Alternatively, a developer manually triggers a review via the CLI, or an external system triggers a review via the API. The code ingestion module 102 captures the event and retrieves the code changeset along with associated contextual metadata.
Step 2—Configuration Loading: The agentic AI module 104 accesses the configuration subsystem 106 to load applicable configuration parameters. Configuration is resolved hierarchically, with more specific levels overriding less specific levels.
Step 3—Contextual Evaluation: The agentic AI module 104 evaluates the code changeset and contextual metadata, including author identity, commit history, file types, programming languages, directory structure, merge request description, and any other available contextual signals.
Step 4—Review Strategy Determination: Based on the contextual evaluation and loaded configuration, the agentic AI module 104 autonomously determines a review strategy. This includes selecting which external analysis tools and/or sub-agent modules to invoke, determining the order of invocation, specifying the inputs and parameters for each tool or sub-agent, and establishing quality thresholds for the review output.
Step 5—Dynamic Tool and Sub-Agent Invocation: The agentic AI module 104 executes the review strategy by invoking the selected external analysis tools 204 and/or sub-agent modules 202. Tool invocation is dynamic—the agentic AI module 104 may adjust the execution plan based on intermediate results (e.g., if an initial analysis reveals security-sensitive code, a security sub-agent may be additionally invoked even if not in the original plan).
Step 6—Output Aggregation: The agentic AI module 104 collects and aggregates outputs from all invoked tools and sub-agents. Outputs are normalized into a common format for synthesis.
Step 7—Feedback Synthesis: The agentic AI module 104 synthesizes the aggregated outputs into structured, context-aware review feedback expressed in natural language. The synthesis takes into account the original code changeset, contextual metadata, configuration parameters, and the specific outputs from each tool and sub-agent. The resulting feedback may include inline code comments positioned at specific locations within the changeset, an overall review summary, actionable improvement suggestions, and a description of the code changeset.
Step 8—Self-Review (Optional): The agentic AI module 104 evaluates whether the synthesized feedback satisfies configured quality thresholds, completeness criteria, and contextual relevance. If the feedback is insufficient, the system may conditionally repeat Steps 4 through 7 with adjusted inputs, additional tool invocations, or refined synthesis parameters.
Step 9—Feedback Delivery: The feedback delivery engine 108 formats and transmits the final review feedback through the configured delivery channels.

### Embodiment 3: Illustrative Examples

The following examples demonstrate how the system operates in practical development scenarios:

### Example A: Cross-File Consistency Check

A developer submits a pull request that modifies a function signature in one file. The agentic AI module 104 evaluates the changeset and identifies that the modified function is invoked in multiple other files within the repository. The AI module invokes a static analyzer to check for potential inconsistencies and determines that one calling site does not include appropriate input validation for the new parameter. The system generates an inline comment at the relevant calling site, explaining the inconsistency and suggesting parameter sanitization.

### Example B: Security-Sensitive Code Detection

When the agentic AI module 104 encounters code that processes external user input in a backend API route, it dynamically invokes a security sub-agent module. The security sub-agent receives the narrowed diff context and specific goals (e.g., evaluate for SQL injection, XSS, and authentication bypass vulnerabilities). The sub-agent returns structured findings, which the agentic AI module synthesizes into natural-language feedback with specific remediation suggestions.

### Example C: Multi-Language Project Analysis

A developer submits a changeset spanning Python backend code, JavaScript frontend code, and SQL migration files. The agentic AI module 104 evaluates the file types and dynamically delegates to appropriate analysis tools for each language: a Python linter for the backend code, a JavaScript linter and accessibility checker for the frontend code, and a SQL optimization analyzer for the migration files. The results are aggregated and synthesized into a unified review summary aligned with team-defined quality thresholds.

### Example D: Custom Style Rule Interpretation

A repository includes a configuration file specifying custom coding conventions, such as naming consistency rules, directory layout preferences, and preferred file structuring patterns. The agentic AI module 104 interprets these repository-specific guidelines and evaluates the code changeset against both the configured static style rules and contextual project patterns. The resulting feedback addresses convention violations with explanations tailored to the specific customs of the repository, exceeding the output of standard linters by incorporating developer-defined practices and commit context.

### Example E: Context-Sensitive Refactoring Recommendation

The agentic AI module 104 encounters complex conditional logic or deeply nested structures within a changeset. Rather than simply flagging code complexity (as a static analyzer might), the AI module evaluates whether simplification could improve readability or maintainability. The system synthesizes explanations for alternative refactoring strategies, including their potential implications for code organization and testability, providing the developer with actionable architectural guidance.

### Example F: Html Accessibility Analysis

A developer submits changes to HTML template files. The agentic AI module 104 detects the HTML changes and invokes an accessibility checker tool. The tool's output is synthesized into inline suggestions for improving compliance with accessibility standards (e.g., WCAG), with natural-language explanations of why each suggestion improves accessibility.

### Example G: SQL Query Optimization

The agentic AI module 104 identifies SQL changes within a changeset and triggers a SQL optimization analyzer. The analyzer's output is synthesized into feedback that explains potential performance implications and suggests query optimizations, with contextual reasoning about the expected data patterns based on the repository's domain.

### Embodiment 4: Orchestration Vs. Tool Chaining

In contrast to traditional static tool pipelines that execute tools in a predetermined sequence (e.g., linter→test runner→formatter), the present system employs an agentic AI module that dynamically orchestrates tool invocation. The agentic AI module evaluates repository configuration, file types, and metadata such as commit content or author before selecting and sequencing the appropriate tools or sub-agents. This orchestration may include conditional execution (e.g., invoking a security scanner only when security-relevant files are modified), context-based prioritization (e.g., prioritizing type checking for TypeScript files), and skipping irrelevant tools (e.g., not invoking a Python linter for JavaScript-only changes). This approach enables a more adaptive and intelligent code review process that allocates analytical resources based on the specific needs of each code changeset.

### Embodiment 5: Alternative Deployment Configurations

The invention supports various deployment configurations:
Cloud-based deployment: All system components operate in a cloud environment, leveraging cloud-based AI services and scalable infrastructure.—On-premises deployment: All system components, including the agentic AI module and analysis tools, operate within a private infrastructure environment behind a firewall with no dependency on third-party cloud services. This configuration is suitable for high-security organizations or regulated industries.—Hybrid deployment: Some components (e.g., the code ingestion module and feedback delivery engine) operate in the cloud while others (e.g., the agentic AI module and security-sensitive analysis tools) operate on-premises.

### Embodiment 6: Alternative AI Implementations

The agentic AI module may be implemented using various AI technologies:
Large language model (LLM) based: The preferred embodiment uses one or more LLMs for planning, orchestration reasoning, and natural language feedback synthesis.—Rule-based engine with NLP: In constrained environments, the agentic AI module may use rule-based decision engines combined with natural language processing (NLP) components for feedback generation.—Hybrid AI: A combination of ML models, rule-based logic, and LLMs may be used, with different components handling different aspects of the review process.

### Embodiment 7: IDE Integration

In a further embodiment, the system is integrated directly into an integrated development environment (IDE) as a plugin or extension. This variation allows the agentic AI module to provide real-time feedback as the developer writes code, supplementing or replacing feedback that would otherwise be delivered during continuous integration (CI) workflows or pull request review cycles.

### How to Make and Use the Invention

### Preferred Implementation

To construct the system, a developer or organization integrates the described modules using standard programming languages and development tools. The agentic AI module 104 can be built using existing LLM APIs (e.g., cloud-hosted language model services) or locally deployed models and configured through YAML or JSON-based repository configuration files. External analysis tools 204 may be orchestrated via shell scripts, language-specific plugins, containerized services (e.g., Docker containers), or API calls. Configuration files may be checked into the same repository as the code being reviewed or managed through centralized settings. Output feedback may be relayed via source control system APIs (e.g., GitHub API, GitLab API), standalone dashboards, CLI output, or email services.

In one preferred embodiment: 1. A webhook endpoint is registered with a source control system (e.g., GitHub) to receive event notifications for pull request creation and update events. 2. Upon receiving a webhook event, the code ingestion module retrieves the relevant code diff, file contents, commit messages, and author information via the source control system's API. 3. The agentic AI module loads repository-specific configuration from a configuration file (e.g., .review-config.yml) stored in the repository root. 4. The agentic AI module evaluates the changeset, determines a review strategy, and invokes appropriate external tools and sub-agents. 5. Tool outputs are aggregated and synthesized by the agentic AI module using an LLM to generate natural-language review comments. 6. The feedback delivery engine posts inline comments and a review summary to the pull request via the source control system's API.

What is claimed is:

1. A system for automated software code review, comprising:
a) a code ingestion module configured to receive a software code changeset from a source control system via at least one of: a webhook notification, a command-line interface (CLI) command, or an application programming interface (API) request;
b) an agentic artificial intelligence (AI) module comprising at least one machine learning model, the AI module configured to:
receive the software code changeset from the code ingestion module;
evaluate contextual metadata associated with the code changeset, the contextual metadata comprising at least one of: author identity, commit history, file types, repository-specific configuration rules, and merge request description;
autonomously determine a review strategy based on the contextual metadata and one or more configuration parameters;
selectively invoke one or more external analysis tools or sub-agent modules based on the determined review strategy;
aggregate outputs from the one or more external analysis tools or sub-agent modules; and
synthesize the aggregated outputs into structured, context-sensitive review feedback expressed in natural language;
c) a configuration subsystem comprising one or more machine-readable configuration files governing at least one of: analysis tool selection, feedback scope, output structure, and review criteria, the configuration subsystem being customizable on a per-repository, per-organization, per-team, or per-user basis; and
d) a feedback delivery engine configured to transmit the structured, context-sensitive review feedback to at least one of: inline comments on a source code repository interface, a command-line interface output, an email notification, a dashboard display, or an API response.

2. The system of claim 1, wherein the agentic AI module comprises a large language model (LLM) configured to generate the natural language review feedback.

3. The system of claim 1, wherein the one or more external analysis tools comprise at least one of: a static code analyzer, a linter, a security scanner, a compiler, a code formatter, or a performance profiler.

4. The system of claim 1, wherein the one or more sub-agent modules comprise specialized AI modules, each configured to perform a scoped analytical task and return structured signals to the agentic AI module as part of a delegation protocol.

5. The system of claim 4, wherein the delegation protocol comprises the agentic AI module providing each sub-agent module with a narrowed subset of files or diff context together with specific analytical goals, and each sub-agent module returning structured results to the agentic AI module for aggregation.

6. The system of claim 1, wherein the agentic AI module is further configured to:
perform a self-review of the synthesized review feedback to evaluate quality, relevance, and completeness of the review feedback against configured review criteria, wherein the self-review evaluates the review feedback itself rather than the underlying code; and
conditionally repeat the review strategy determination and tool invocation with an adjusted review strategy including modified tool selection or sub-agent delegation parameters responsive to the self-review evaluation.

7. The system of claim 1, wherein the contextual metadata further comprises at least one of: programming language of files in the code changeset, directory structure, continuous integration (CI) pipeline status, and code complexity metrics.

8. The system of claim 1, wherein the configuration subsystem supports hierarchical configuration with defined precedence semantics, wherein organization-level configuration parameters serve as defaults that are selectively overridable by repository-level, team-level, or user-level configuration parameters, and wherein conflicts between configuration levels are resolved according to a specificity-based merge strategy in which more specific levels take precedence over less specific levels for applicable parameters.

9. The system of claim 1, wherein the agentic AI module dynamically selects which of the one or more external analysis tools to invoke based on at least one of: file type of files within the changeset, programming language, configured quality thresholds, or characteristics of the code changeset.

10. The system of claim 1, wherein the code ingestion module is configured to process code changesets comprising at least one of: text files, binary files, image files, configuration files, and multimedia files.

11. The system of claim 1, wherein the feedback delivery engine is configured to deliver feedback comprising at least one of: inline code comments positioned at specific locations within the changeset, a summary of the overall review, actionable improvement suggestions, and a description of the code changeset.

12. A computer-implemented method for automated software code review using an agentic artificial intelligence (AI) system, the method comprising:
a) receiving, by a code ingestion module, a software code changeset from a source control system;
b) accessing one or more configuration files governing tool selection, feedback scope, review criteria, and output structure;
c) evaluating, by an agentic AI module, the software code changeset and associated contextual metadata, the contextual metadata comprising at least one of: author identity, timestamp, file type, commit history, and merge request description;
d) determining, by the agentic AI module, a review strategy based on the contextual metadata and the one or more configuration files;
e) selectively invoking, by the agentic AI module, one or more external analysis tools or sub-agent modules based on the review strategy, wherein the selection is performed dynamically based on at least one of: file type, programming language, repository configuration, or code characteristics;
f) aggregating outputs from the one or more external analysis tools or sub-agent modules;
g) synthesizing, by the agentic AI module, the aggregated outputs into structured, context-aware review feedback expressed in natural language; and
h) delivering the review feedback to at least one delivery channel comprising: inline comments on a source code repository interface, a CLI output, an email notification, or an API response.

13. The method of claim 12, further comprising: evaluating, by the agentic AI module, whether the synthesized review feedback satisfies configured completeness thresholds or contextual review criteria, wherein the evaluation assesses the quality and completeness of the review feedback itself rather than the underlying code being reviewed; and conditionally repeating steps (d) through (g) with an adjusted review strategy including modified tool selection or sub-agent delegation parameters responsive to the evaluation.

14. The method of claim 12, wherein the synthesizing step comprises using a large language model (LLM) to generate the natural language review feedback based on the aggregated outputs and the contextual metadata.

15. The method of claim 12, wherein the selectively invoking step comprises delegating, by the agentic AI module, one or more scoped analytical tasks to respective sub-agent modules, each sub-agent module receiving a narrowed context and specific analytical goals from the agentic AI module.

16. The method of claim 12, wherein the one or more configuration files are stored within the source code repository and are version-controlled alongside the software code.

17. The method of claim 12, further comprising: dynamically orchestrating the one or more external analysis tools in a non-predetermined sequence, wherein the agentic AI module determines the sequence based on contextual evaluation of intermediate results.

18. The method of claim 12, wherein the code changeset comprises modifications across multiple programming languages, and the selectively invoking step comprises invoking different external analysis tools for different programming languages within the same changeset.

19. A non-transitory computer-readable medium storing instructions that, when executed by one or more processors, cause the one or more processors to perform operations comprising:
a) receiving a software code changeset from a source control system via at least one of: a webhook notification, a command-line interface command, or an application programming interface request;
b) accessing one or more configuration parameters customizable on at least one of: a per-repository, per-organization, per-team, or per-user basis;
c) evaluating, by an agentic artificial intelligence module, the code changeset and contextual metadata associated therewith;
d) autonomously determining a review strategy and selectively invoking one or more external analysis tools or sub-agent modules based on the review strategy;
e) aggregating and synthesizing outputs from the invoked tools or sub-agent modules into structured review feedback expressed in natural language; and
f) delivering the structured review feedback via at least one configured delivery channel.

20. The non-transitory computer-readable medium of claim 19, wherein the operations further comprise: performing a self-evaluation of the structured review feedback against configured quality thresholds, wherein the self-evaluation assesses the quality and completeness of the review feedback itself rather than the underlying code being reviewed; and iteratively refining the review feedback by re-invoking one or more external analysis tools or sub-agent modules with an adjusted review strategy including modified tool selection or sub-agent delegation parameters responsive to the self-evaluation.
